(19) United States
(12) Patent Application Publication
(10) Pub. No.: US 2019/0186598 A1
(43) Pub. Date: Jun. 20, 2019

(54) APPARATUS AND SYSTEM FOR THIN RIM PLANET GEAR FOR AIRCRAFT ENGINE POWER GEARBOX

(71) Applicant: General Electric Company, Schenectady, NY (US)

(72) Inventors: Kennneth Lee Fisher, Schenectady, NY (US); Darren Lee Hallman, Scotia, NY (US); Bugra Han Ertas, Niskayuna, NY (US); Donald Albert Bradley, Royal Oak, MI (US); Haris Ligata, Lancaster, NY (US); William Howard Hasting, Paris (FR); Ning Fang, Mason, OH (US); Gert Johannes van der Merwe, Lebanon, OH (US); Mark Alan Rhoads, Cincinnati, OH (US)

(21) Appl. No.: 16/284,358

(22) Filed: Feb. 25, 2019

Related U.S. Application Data
(63) Continuation-in-part of application No. 14/984,472, filed on Dec. 30, 2015, now abandoned.

(51) Int. Cl. F16H 1/28; F16C 19/36; F02C 7/36; F16H 57/08

(52) U.S. Cl. CPC F16H 1/2809; F16H 57/082; F02C 7/36; F16C 19/361

(57) ABSTRACT

A planet gear includes an annular planet gear rim having a constant inner radius along a complete axial length and an outer radius defined as the radial distance to the root of the gear teeth. The annular planet gear rim further has an average rim radius defined at a halfway point between the constant inner radius and the outer radius. The average rim radius and the rim thickness define a ratio including values in a range from and including about 4 to and including about 9. A gear assembly and turbomachine including the planet gear are disclosed.

### BACKGROUND

The field of the disclosure relates generally to systems and methods for managing loads on a gearbox in aviation engines and, more particularly, to an apparatus and system for a thin rimmed planet gear in a gearbox in aviation engines.

Aircraft engines typically include a fan, a low pressure compressor, and a low pressure turbine rotationally coupled in a series configuration by a low pressure shaft. The low pressure shaft is rotationally coupled to the low pressure turbine and a power gear box. The power gear box includes a plurality of gears and is rotationally coupled to the low pressure fan and low pressure compressor. Aircraft engines may generate significant torsional loads on the low pressure shaft. Torsional loads on the low pressure shaft can exert torsional forces on the gears within the power gear box. Additionally, if not optimally designed these torsional loads transferred through the planet gears can exert unevenly distributed loads on bearing elements within the planet gears. These unevenly distributed loads result in higher peak roller loads which will induce higher contact stresses between the planet gear, the planet rolling elements, and the planet inner race and reduce the reliability of the planet bearings as well as the power gear box.

### BRIEF DESCRIPTION

In one aspect, a planet gear includes an annular planet gear rim and a rolling element bearing assembly. The annular planet gear rim has a constant inner radius along a complete axial length and an outer radius defined as the radial distance to the root of the gear teeth. The constant inner radius and the outer radius define a gear rim thickness therebetween. The annular planet gear rim further has an average rim radius defined at a point halfway between the constant inner radius and the outer radius where transverse components of a plurality of gear tooth forces are applied to the planet gear rim, and wherein a ratio of the average rim radius divided by the rim thickness is in a range of 4 to 9. The rolling element bearing assembly comprises an inner annular bearing ring and a plurality of rolling bearing elements disposed circumferentially around the inner annular bearing ring. The annular planet gear rim is disposed circumferentially about the plurality of rolling bearing elements, and wherein the plurality of rolling bearing elements are axially retained by the inner annular bearing ring.

In another aspect, a gear assembly includes a sun gear, a ring gear and a plurality of planet gears coupled to the ring gear and the sun gear. Each planet gear of the plurality of planet gears comprises an annular planet gear rim and a rolling element bearing assembly. The annular planet gear rim has a constant inner radius along a complete axial length and an outer radius defined as the radial distance to the root of the gear teeth. The constant inner radius and the outer radius define a gear rim thickness therebetween. The annular planet gear rim further has an average rim radius defined at a point between the constant inner radius and the outer radius where stresses and strains within the planet gear rim are zero when radial and transverse components of a plurality of gear tooth forces are applied to the planet gear rim, and wherein a ratio of the average rim radius divided by the rim thickness is in a range of 4 to 9. The rolling element bearing assembly comprises an inner annular bearing ring and a plurality of rolling bearing elements disposed circumferentially around the inner annular bearing ring. The annular planet gear rim is disposed circumferentially about the plurality of rolling bearing elements. The plurality of rolling bearing elements are axially retained by the inner annular bearing ring.

In yet another aspect, a turbomachine includes a power shaft and a gear assembly. The power shaft is rotationally coupled to the gear assembly. The gear assembly comprises a sun gear, a ring gear and a plurality of planet gears coupled to the ring gear and the sun gear. Each planet gear of the plurality of planet gears comprises an annular planet gear rim and a rolling element bearing assembly. The annular planet gear rim has a constant inner radius along a complete axial length and an outer radius defined as the radial distance to the root of the gear teeth. The constant inner radius and the outer radius define a gear rim thickness therebetween. The annular planet gear rim further has an average rim radius defined at a point between the constant inner radius and the outer radius where stresses and strains within the planet gear rim are zero when radial and transverse components of a plurality of gear tooth forces are applied to the planet gear rim, and wherein a ratio of the average rim radius divided by the rim thickness is in a range of 4 to 9. The rolling element bearing assembly comprises an inner annular bearing ring and a plurality of rolling bearing elements disposed circumferentially around the inner annular bearing ring. The annular planet gear rim is disposed circumferentially about the plurality of rolling bearing elements. The plurality of rolling bearing elements are axially retained by the inner annular bearing ring.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic longitudinal cross-sectional view of an exemplary gas turbine engine, in accordance with one or more embodiment of the present disclosure;

FIG. 2 is a schematic cross-sectional view of an exemplary epicyclic gear train that is used with the gas turbine engine shown in FIG. 1, in accordance with one or more embodiment of the present disclosure;

FIG. 3 is a longitudinal cross-sectional view of an exemplary planet gear that is used with the epicyclic gear train shown in FIG. 2, in accordance with one or more embodiment of the present disclosure;

FIG. 4 is a schematic cross-sectional view of the exemplary planet gear of FIG. 3 and taken along line 4-4 of FIG. 3, in accordance with one or more embodiment of the present disclosure; and

FIG. 5 is a schematic cross-sectional view of the planet gear shown in FIG. 3 with resultant tangential and radial forces causing the planet gear rim to deflect, in accordance with one or more embodiment of the present disclosure.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of the thin rimmed planet gear described herein manage resultant tangential and radial loads in a power gearbox in a turbomachine, e.g. an aircraft engine. The thin rimmed planet gear includes a planet gear rim, a plurality of gear teeth, an annular inner bearing ring, and a plurality of rolling elements. The rolling elements are disposed circumferentially around the annular inner bearing ring. The planet gear rim circumscribes and rotates about the rolling elements. The gear teeth are disposed circumferentially about an outer radial surface of the planet gear rim. A sun gear and a low pressure power shaft are configured to rotate the thin rimmed planet gear through a plurality of complementary teeth circumferentially spaced about a radially outer periphery of the sun gear. The low pressure power shaft exerts torsional forces on the sun gear which exerts forces through the planet gear balanced by equal and opposite forces on the ring gear and creates a reaction force through the rolling elements, the inner ring and the pin/shaft. The planet gear rim of the thin rimmed planet gear deflects and more evenly distributes the forces across the rolling elements. Better distribution of the forces across a maximum number of rolling elements reduces the contact stresses on the planet gear bearing surface, the rolling elements, and the inner race and increases the reliability of the planet bearing and the power gear box. A planet gear with the proper planet gear rim thickness will deflect enough, but not too much, such that the reliability of planet bearing is increased.

The planet gear described herein offers advantages over known planet gears in aircraft engines. More specifically, the thin rimmed planet gear described herein deflects as resultant radial and tangential forces are applied to it from the sun gear and from the ring gear. Planet gear rim deflection more evenly distributes the forces across the rolling elements which decreases the contact stresses on the planet gear bearing surface, the rolling elements, and the inner race and increases the reliability of the planet bearing and the power gearbox. Furthermore, the thin rimmed planet gear described herein reduces the weight of the aircraft by reducing the amount of material in the planet gear.

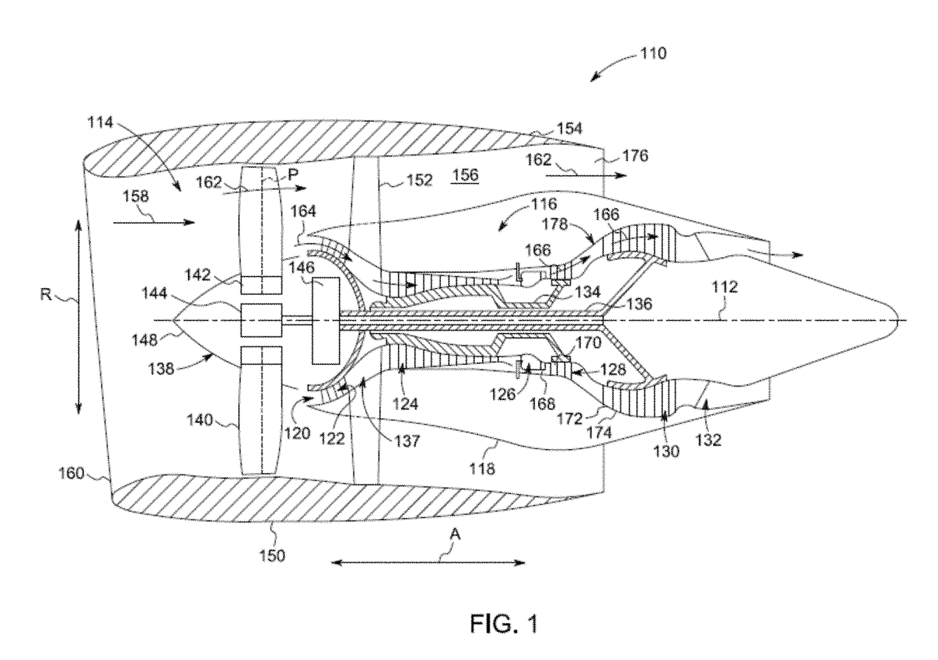

Referring now to the drawings, it is noted that like numerals refer to like elements throughout the several views and that the elements shown in the Figures are not drawn to scale and no dimensions should be inferred from relative sizes and distances illustrated in the Figures. FIG. 1 is a schematic cross-sectional view of a gas turbine engine 110 in accordance with an exemplary embodiment of the present disclosure. In the exemplary embodiment, gas turbine engine 110 is a high-bypass turbofan jet engine 110, referred to herein as “turbofan engine 110.” As shown in FIG. 1, turbofan engine 110 defines an axial direction A (extending parallel to a longitudinal centerline 112 provided for reference) and a radial direction R. In general, turbofan engine 110 includes a fan section 114 and a core turbine engine 116 disposed downstream from fan section 114.

Exemplary core turbine engine 116 depicted generally includes a substantially tubular outer casing 118 that defines an annular inlet 120. Outer casing 118 encases, in serial flow relationship, a compressor section 123 including a booster or low pressure (LP) compressor 122 and a high pressure (HP) compressor 124; a combustion section 126; a turbine section including a high pressure (HP) turbine 128 and a low pressure (LP) turbine 130; and a jet exhaust nozzle section 132. A high pressure (HP) shaft or spool 134 drivingly connects HP turbine 128 to HP compressor 124. A low pressure (LP) shaft or spool 136 drivingly connects LP turbine 130 to LP compressor 122. The compressor section 123, combustion section 126, turbine section, and nozzle section 132 together define a core air flowpath 137.

For the embodiment depicted, fan section 114 includes a variable pitch fan 138 having a plurality of fan blades 140 coupled to a disk 142 in a spaced apart manner. As depicted, fan blades 140 extend outwardly from disk 142 generally along radial direction R. Each fan blade 140 is rotatable relative to disk 142 about a pitch axis P by virtue of fan blades 140 being operatively coupled to a suitable pitch change mechanism 144 configured to collectively vary the pitch of fan blades 140 in unison. Fan blades 140, disk 142, and pitch change mechanism 144 are together rotatable about longitudinal axis 112 by LP shaft 136 across a power gear box 146. Power gear box 146 includes a plurality of gears for adjusting the rotational speed of fan 138 relative to LP shaft 136 to a more efficient rotational fan speed. In an alternative embodiment, fan blade 140 is a fixed pitch fan blade rather than a variable pitch fan blade.

Also, in the exemplary embodiment, disk 142 is covered by rotatable front hub 148 aerodynamically contoured to promote an airflow through plurality of fan blades 140. Additionally, exemplary fan section 114 includes an annular fan casing or outer nacelle 150 that circumferentially surrounds fan 138 and/or at least a portion of core turbine engine 116. Nacelle 150 is configured to be supported relative to core turbine engine 116 by a plurality of circumferentially-spaced outlet guide vanes 152. A downstream section 154 of nacelle 150 extends over an outer portion of core turbine engine 116 so as to define a bypass airflow passage 156 therebetween.

During operation of turbofan engine 110, a volume of air 158 enters turbofan engine 110 through an associated inlet 160 of nacelle 150 and/or fan section 114. As volume of air 158 passes across fan blades 140, a first portion of air 158 as indicated by arrows 162 is directed or routed into bypass airflow passage 156 and a second portion of air 158 as indicated by arrow 164 is directed or routed into core air flowpath 137, or more specifically into LP compressor 122. The ratio between first portion of air 162 and second portion of air 164 is commonly known as a bypass ratio. The pressure of second portion of air 164 is then increased as it is routed through HP compressor 124 and into combustion section 126, where it is mixed with fuel and burned to provide combustion gases 166.

Combustion gases 166 are routed through HP turbine 128 where a portion of thermal and/or kinetic energy from combustion gases 166 is extracted via sequential stages of HP turbine stator vanes 168 that are coupled to outer casing 118 and HP turbine rotor blades 170 that are coupled to HP shaft or spool 134, thus causing HP shaft or spool 134 to rotate, thereby supporting operation of HP compressor 124. Combustion gases 166 are then routed through LP turbine 130 where a second portion of thermal and kinetic energy is extracted from combustion gases 166 via sequential stages of LP turbine stator vanes 172 that are coupled to outer casing 118 and LP turbine rotor blades 174 that are coupled to LP shaft or spool 136, thus causing LP shaft or spool 136 to rotate which causes power gear box 146 to rotate LP compressor 122 and/or rotation of fan 138.

Combustion gases 166 are subsequently routed through jet exhaust nozzle section 132 of core turbine engine 116 to provide propulsive thrust. Simultaneously, the pressure of first portion of air 162 is substantially increased as first portion of air 162 is routed through bypass airflow passage 156 before it is exhausted from a fan nozzle exhaust section 176 of turbofan engine 110, also providing propulsive thrust. HP turbine 128, LP turbine 130, and jet exhaust nozzle section 132 at least partially define a hot gas path 178 for routing combustion gases 166 through core turbine engine 116.

Exemplary turbofan engine 110 depicted in FIG. 1 is by way of example only, and that in other embodiments, turbofan engine 110 may have any other suitable configuration. It should also be appreciated, that in still other embodiments, aspects of the present disclosure may be incorporated into any other suitable gas turbine engine. For example, in other embodiments, aspects of the present disclosure may be incorporated into, e.g., a turboprop engine.

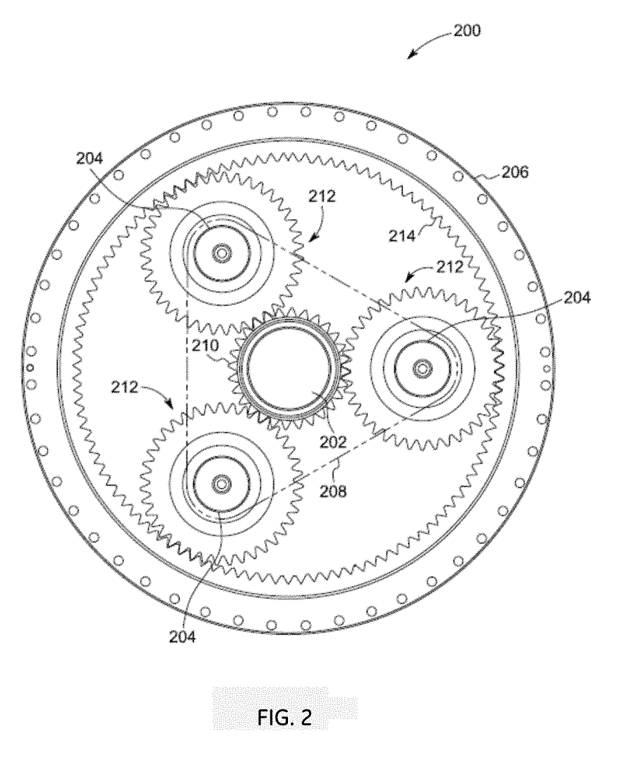

FIG. 2 is a schematic diagram of an epicyclic gear train 200. In the exemplary embodiment, epicyclic gear train 200 is a planetary gear train. In one embodiment, epicyclic gear train 200 is housed within power gearbox 146 (shown in FIG. 1). In other embodiments, epicyclic gear train 200 is located adjacent to power gearbox 146 and is mechanically coupled to it. As an example, the epicyclic gear train 200 is for use in an aircraft engine geared drive fan system.

Epicyclic gear train 200 includes a sun gear 202, a plurality of planetary gears 204, a ring gear 206, and a carrier 208. In alternative embodiments, epicyclic gear train 200 is not limited to three planetary gears 204. Rather, any number of planetary gears may be used that enables operation of epicyclic gear train 200 as described herein. In some embodiments, LP shaft or spool 136 (shown in FIG. 1) is fixedly coupled to sun gear 202. Sun gear 202 is configured to engage planetary gears 204 through a plurality of complementary sun gear teeth 210 and a plurality of complementary planet gear teeth 212 circumferentially spaced about a radially outer periphery of sun gear 202 and a radially outer periphery of planetary gears 204 respectively. Planetary gears 204 are maintained in a position relative to each other using carrier 208. Planetary gears 204 are fixedly coupled to power gearbox 146. Planetary gears 204 are configured to engage ring gear 206 through a plurality of complementary ring gear teeth 214 and complementary planet gear teeth 212 circumferentially spaced about a radially inner periphery of ring gear 206 and a radially outer periphery of planetary gears 204 respectively. Ring gear 206 is rotationally coupled to fan blades 140 (shown in FIG. 1), disk 142 (shown in FIG. 1), and pitch change mechanism 144 (shown in FIG. 1) extending axially from ring gear 206. LP turbine 130 rotates the LP compressor 122 at a constant speed and torque ratio which is determined by a function of ring gear teeth 214, planet gear teeth 212, and sun gear teeth 210 as well as how power gearbox 146 is restrained.

Epicyclic gear train 200 can be configured in three possible configuration: planetary, star, and solar. In the planetary configuration, ring gear 206 remains stationary while sun gear 202, planetary gears 204, and carrier 208 rotate. LP shaft or spool 136 drives sun gear 202 which is configured to rotate planetary gears 204 that are configured to rotate carrier 208. Carrier 208 drives fan blades 140, disk 142, and pitch change mechanism 144. Sun gear 202 and carrier 208 rotate in the same direction.

In the star configuration, carrier 208 remains stationary while sun gear 202 and ring gear 206 rotate. LP shaft or spool 136 drives sun gear 202 which is configured to rotate planetary gears 204. Planetary gears 204 are configured to rotate ring gear 206 and carrier 208 is fixedly coupled to power gearbox 146. Carrier 208 maintains planetary gears 204 positioning while allowing planetary gears 204 to rotate on their respective bearings. Ring gear 206 is rotationally coupled to fan blades 140, disk 142, and pitch change mechanism 144. Sun gear 202 and ring gear 206 rotate in opposite directions.

In the solar configuration, sun gear 202 remains stationary while planetary gears 204, ring gear 206, and carrier 208 rotate. LP shaft or spool 136 can drive either the ring gear 206 or carrier 208. When LP shaft or spool 136 is coupled to carrier 208, planetary gears 204 are configured to rotate ring gear 206 which drives fan blades 140, disk 142, and pitch change mechanism 144. Ring gear 206 and carrier 208 rotate in the same direction.

In the solar configuration where LP shaft or spool 136 is coupled to ring gear 206, ring gear 206 is configured to rotate planetary gears 204 and carrier 208. Carrier 208 drives fan blades 140, disk 142, and pitch change mechanism 144. Ring gear 206 and carrier 208 rotate in the same direction.

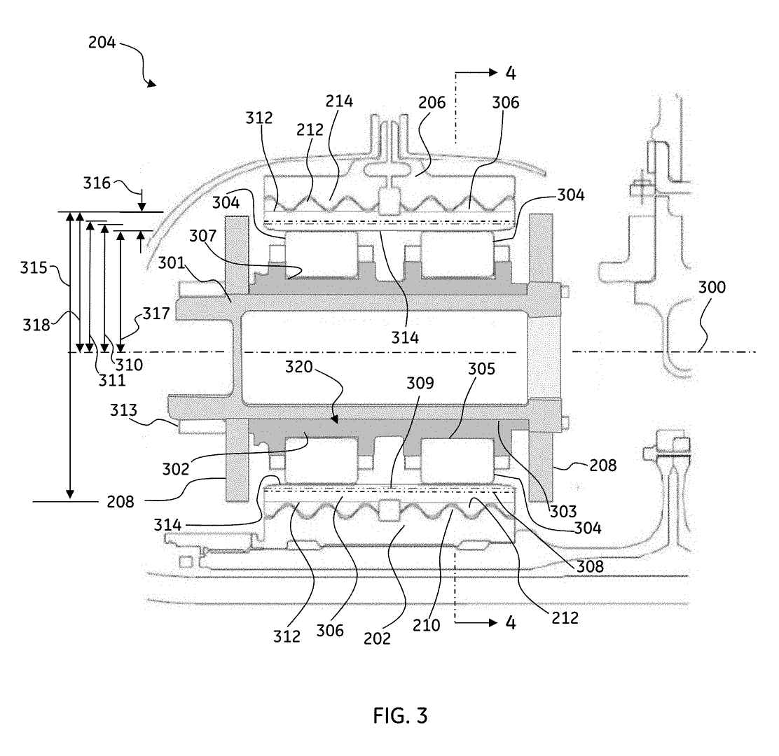

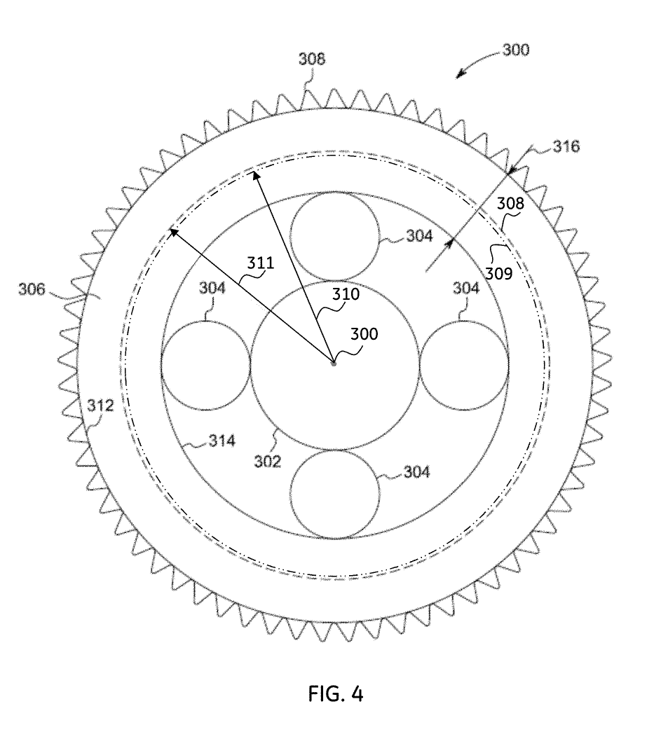

Referring now to FIGS. 3 and 4, illustrated is a longitudinal cross-sectional view of the exemplary planet gear 204 of the epicyclic gear train shown in FIG. 2, and a schematic cross-sectional view of the exemplary planet gear 204 of FIG. 3, taken along line 4-4 of FIG. 3, respectively. The planet gear 204 is rotatable about an axis 300 via a pin 301. It should be noted that the terms pin and shaft are used interchangeably herein as they refer to the component that the planet gear 204 rotates about. The planet gear 204 includes a planet gear rim 306, a plurality of teeth 212, and a rolling element bearing assembly 320, comprising an inner annular bearing ring 302 and a plurality of rolling elements 304. The plurality of rolling elements 304 are disposed circumferentially around the annular inner bearing ring 302. The carrier 208 (shown in FIG. 2) is coupled to the inner annular bearing ring 302 and the pin 301. The planet gear rim 306 circumscribes the plurality of rolling elements 304. The teeth 212 are disposed circumferentially about an outer radial surface 312. The plurality of teeth 212 are configured to mesh with the sun gear teeth 210 and ring gear teeth 214. More specifically, each planet gear 204 is meshed with the sun gear 202 and the ring gear 206 while being rotatably attached around an outer circumference of the inner annular bearing ring 302, which is used as a rotational shaft, via the plurality of rolling elements 304.

As best illustrated in FIG. 3, the pin 301 has mounted to an outer surface 303, the inner annular bearing ring 302 comprising a plurality of inner races 305 defining a plurality of raceway grooves 307. In the illustrated embodiment, the inner annular bearing ring 302 is configured for mounting to the outer surface 303 of the pin 301 and within the carrier 208 of the gear assembly using any suitable fastening mechanisms. For example, the rolling element bearing assembly 320, and more particularly, the inner annular bearing ring 302 may be coupled to the outer surface 303 of the pin 301 and within the carrier 208 utilizing known coupling means such as, but not limited to, press fit, wedge, and/or a combination of known coupling means. The plurality of rolling elements 304 are disposed within the inner races 305, and more particularly the plurality of raceway grooves 307, so as to provide axial restraint of the plurality of rolling elements 304, thus maintaining alignment of the rolling elements 304 relative to the planet gear 204. A fastener 313, such as a spanner nut, couples the pin 301, the inner annular bearing ring 302 and the carrier 208 together.

During assembly, the planet bearing assembly, and more specifically, the inner annular bearing ring 302, the plurality of rolling elements 304, the carrier 208 and the geared planet gear rim 306, is disposed within a space. Next, the pin 301 is inserted through the carrier 208 into a center of the bearing assembly and held in place by the interference fit between the pin 301 and the carrier 208 at the ends. Subsequently, the fastener 313 is positioned on the pin 301 and is drawn up against the carrier 208 to pull the bearing component tight and securely tying the assembly together.

The planet gear rim 306 includes a planet gear bending stress neutral axis 309, a planet gear bending stress neutral axis radius 310, a planet gear average rim axis 308, a planet gear average rim radius 311, the outer radial surface 312, or gear root diameter 315, a constant inner radial surface 314, and a gear rim thickness 316. The planet gear bending stress neutral axis radius 310 is the radius where the stresses and strains within planet gear rim 306 are zero when bending forces are applied to planet gear 204. The gear rim thickness 316 is the radial distance between the outer radial surface 312 and the inner radial surface 314. The halfway point between the inner radial surface 314 and the outer radial surface 314 defines the location of the average rim axis 308 and the average rim radius 311. The planet gear average rim radius 311 and the rim thickness 316 define a ratio including values in a range from and including about 4 to and including about 9.

As illustrated, the annular planet gear rim bending stress neutral axis radius 310 is defined at a point near an average of a radius 317 of the constant inner radial surface 314 and a radius 318 of the outer radial surface 312 where stresses and strains within the planet gear rim 306 are zero when radial and transverse components of a plurality of gear tooth forces are applied to the planet gear rim 306, and more particularly near the planet gear average rim radius 311.

As previously alluded to, and as best illustrated in FIG. 3, the inner radial surface 314 has a constant radius 317 along a complete axial length. As such language indicates, this type of configuration is typically referred to as an inner land guided bearing design whereby the constant inner radius 317 of the planet gear rim 306 defines a straight or plain raceway without guide flanges. For an inner land guided bearing design, the shoulders or flanges are defined by the races 307, as previously described, and serve to guide the plurality of rolling elements 304.

This inner land guided bearing design, and more particularly the design including the planet gear rim 306 having a constant inner radius 317, provides a plurality of benefits over known configurations. The constant inner radius 317 of the planet gear rim 306 results in the constant average rim radius 311. In contrast, a design with guide flanges would result in step changes in the average rim radius with every thickness change along the axis of the gear. The resulting changes in thickness and stiffness would cause variations in the raceway contour and may result in local variations in surface contact forces and stresses. Furthermore, in a variable radius gear bore design, the neutral axis (near average radius) would not be a constant. The bending stiffness will not be as readily calculated and the effect of whatever section is taken to define rim thickness ratio will be highly different.

The constant radius or straight bore design as disclosed herein, provides a uniformity that minimizes variations and promotes reliability. A significant reliability benefit of the constant radius or straight bore design is that is can more easily shed debris that may collect in the system. With an outer land guided bearing design and a rotating gear, centrifugal forces would tend to trap particles within an artificial gravity well formed by the guide flanges. With a constant radius design, particles have a chance to escape axially to either side with the flow of oil and splash. Shutdown periods provide a reduced and zero g-field where particles may flow out with the residual oil. In addition, the inner land guided bearing design disclosed herein has manufacturing benefits, keeping the more complex machining on the easily accessible outer surface 304 of the inner annular bearing ring 302.

Planet gear 204 includes at least one material selected from a plurality of alloys including, without limitation, ANSI M50 (AMS6490, AMS6491, and ASTM A600), M50 Nil (AMS6278), Pyrowear 675 (AMS5930), Pyrowear 53 (AMS6308), Pyrowear 675 (AMS5930), ANSI9310 (AMS6265), 32CDV13 (AMS6481), ceramic (silicon nitride), Ferrium C61 (AMS6517), and Ferrium C64 (AMS6509). Additionally, in some embodiments, the metal materials can be nitrided to improve the life and resistance to particle damages. Planet gear 204 includes any combination of alloys and any percent weight range of those alloys that facilitates operation of planet gear 204 as described herein, including, without limitation combinations of M50 Nil (AMS6278), Pyrowear 675 (AMS5930), and Ferrium C61 (AMS6517).

During operation, depending on the configuration of epicyclic gear train 200 (shown in FIG. 2), sun gear 202 (shown in FIG. 2), ring gear 206 (shown in FIG. 2), or LP power shaft 136 rotates the planet gear 204. The planet gear rim 306 rotates around the rolling elements 304 and the inner annular bearing ring 302. The inner annular bearing ring 302 rotates the carrier 208.

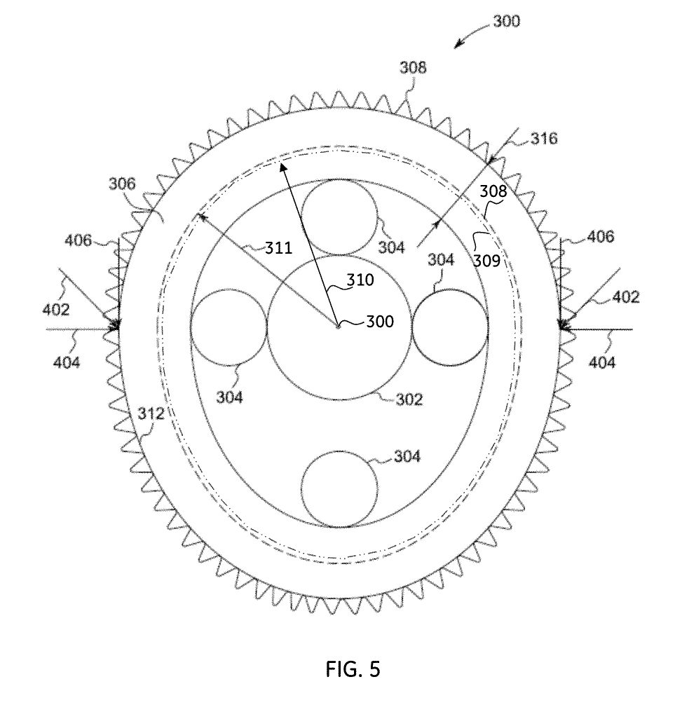

FIG. 5 is a schematic diagram of the planet gear 204 (shown in FIGS. 3 and 4) with resultant radial and transverse forces 402 causing a wraparound effect of the bending planet gear rim 306. Torsional movement of the LP power shaft 136 causes the sun gear 202 (shown in FIG. 2) and the ring gear 206 (shown in FIG. 2) to exert resultant radial and transverse components of the gear tooth forces 402 on the planet gear rim 306. Resultant radial and transverse components of gear tooth forces 402 are equal in magnitude and represent the load through the teeth 212 from the sun gear 202 (shown in FIG. 2) on one side and from the ring gear 206 (shown in FIG. 2) on the other side.

Resultant radial and transverse components of the gear tooth forces 402 include resultant radial component forces 404 and resultant tangential component forces 406. The resultant radial component forces 404 are equal and opposite respective radial components of the resultant radial and transverse components of the gear tooth forces 402. The resultant tangential component forces 406 are equal the respective tangential components of the tooth contact forces 402. The resultant radial and transverse components of the gear tooth forces 402 cause a wraparound effect of the bending planet gear rim 306. The wrap around effect of the bending planet gear rim 306 is caused by both the resultant tangential component forces 406 pulling down and the resultant radial component forces 404 pushing in. The wrap around effect of the bending planet gear rim 306 distributes loads to more rolling elements 304 and, to a point, reduces the peak load on any single rolling element 304. The reduced peak load on the plurality of rolling elements 304 improves the reliability of the rolling elements 304 and the planet gear rim 306. In an embodiment, the planet gear rim 306 deflects to distribute gear tooth forces uniformly to the maximum rolling bearing elements.

Enhanced results are achieved when the gear rim thickness 316 is thick enough to maintain physical integrity but thin enough to deflect. If the gear rim thickness 316 is too low, the planet gear rim 306 wraps around and strains the teeth 212 by adding hoop stress to the tooth bending load, and driving high peak roller loads directly inboard of the gear mesh. Enhanced results are achieved when the planet gear average rim radius 311 and the gear rim thickness 316 define a ratio including values in a range from and including about 3 to and including about 10, and more particularly in a range from and including about 4 to and including about 9. The stated ratio of the planet gear average rim radius 311 to the gear rim thickness 316 provides enhanced distribution of the resultant radial and transverse components of the gear tooth forces 402 over the rolling elements 304.

The above-described thin rimmed planet gear provides an efficient method for managing torsional forces in a turbomachine. Specifically, the planet gear rim deflects as resultant tangential and radial forces are applied to it from the sun gear and the low pressure power shaft and countered by the equal and opposite forces from the ring gear. Planet gear rim deflection more evenly distributes the forces across the rolling elements which reduces the peak load on any single rolling element and improves the reliability of the inner race, the rolling elements and the planet gear rim, which increases the reliability of the inner race, the rolling elements and the planet gear rim. Finally, the thin rimmed planet gear described herein reduces the weight of the aircraft by reducing the amount of material in the planet gear.

An exemplary technical effect of the methods, systems, and apparatus described herein includes at least one of: (a) decreasing the stress and strain on the planet gear rim; (b) decreasing the peak load on rolling elements; (c) increasing the reliability of the planet gear bearings; and (d) decreasing the weight of the aircraft engine.

Exemplary embodiments of the thin rimmed planet gear are described above in detail. The thin rimmed planet gear, and methods of operating such units and devices are not limited to the specific embodiments described herein, but rather, components of systems and/or steps of the methods may be utilized independently and separately from other components and/or steps described herein. For example, the methods may also be used in combination with other systems for managing torsional forces in a turbomachine and are not limited to practice with only the systems and methods as described herein. Rather, the exemplary embodiment may be implemented and utilized in connection with many other machinery applications that require planet gears.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A planet gear comprising:
an annular planet gear rim, said annular planet gear rim having a constant inner radius along a complete axial length and an outer radius defined as the radial distance to the root of the gear teeth, the constant inner radius and the outer radius defining a gear rim thickness therebetween, said annular planet gear rim further having an average rim radius defined at a point halfway between the constant inner radius and the outer radius where transverse components of a plurality of gear tooth forces are applied to the planet gear rim, and wherein a ratio of the average rim radius divided by the rim thickness is in a range of 4 to 9; and
a rolling element bearing assembly comprising an inner annular bearing ring and a plurality of rolling bearing elements disposed circumferentially around the inner annular bearing ring, wherein said annular planet gear rim is disposed circumferentially about said plurality of rolling bearing elements, and wherein said plurality of rolling bearing elements are axially retained by said inner annular bearing ring.

2. The planet gear of claim 0, further comprising a shaft, wherein the rolling element bearing assembly is disposed about the shaft and rotatable therewith.

3. The planet gear of claim 0, wherein said rolling element bearing assembly is coupled to an outer surface of the shaft.

4. The planet gear of claim 3, wherein said coupling means comprise at least one of a press fit and a wedge.

5. The planet gear of claim 1, wherein the average rim radius of the planet gear rim is tunable in response to the plurality of gear tooth forces applied to the planet gear rim.

6. The planet gear of claim 1, wherein the planet gear rim thickness is tunable to improve load sharing of the plurality of rolling bearing elements.

7. The planet gear of claim 1, wherein the planet gear rim deflects to distribute gear tooth forces uniformly to the rolling bearing elements and to the maximum number of rolling elements.

8. A gear assembly comprising:
a sun gear;
a ring gear; and
a plurality of planet gears coupled to said ring gear and said sun gear, wherein each planet gear of said plurality of planet gears comprises:
an annular planet gear rim, said annular planet gear rim having a constant inner radius along a complete axial length and an outer radius defined as the radial distance to the root of the gear teeth, the constant inner radius and the outer radius defining a gear rim thickness therebetween, said annular planet gear rim further having an average rim radius defined at a point between the constant inner radius and the outer radius where stresses and strains within the planet gear rim are zero when radial and transverse components of a plurality of gear tooth forces are applied to the planet gear rim, and wherein a ratio of the average rim radius divided by the rim thickness is in a range of 4 to 9; and
a rolling element bearing assembly comprising an inner annular bearing ring and a plurality of rolling bearing elements disposed circumferentially around the inner annular bearing ring, wherein said annular planet gear rim is disposed circumferentially about said plurality of rolling bearing elements, and wherein said plurality of rolling bearing elements are axially retained by said inner annular bearing ring.

9. The gear assembly of claim 8, wherein said sun gear, said plurality of planet gears, said ring gear, and said carrier are configured in a planetary configuration.

10. The gear assembly of claim 8, wherein said sun gear, said plurality of planet gears, said ring gear, and said carrier are configured in a star configuration.

11. The gear assembly of claim 8, wherein said sun gear, said plurality of planet gears, said ring gear, and said carrier are configured in a solar configuration.

12. The gear assembly of claim 8, further comprising a power shaft coupled to said carrier.

13. The gear assembly of claim 5, further comprising a power shaft coupled to said ring gear.

14. A turbomachine comprising:
a power shaft and a gear assembly, said power shaft rotationally coupled to said gear assembly;
said gear assembly comprising:
a sun gear;
a ring gear; and
a plurality of planet gears coupled to said ring gear and said sun gear, wherein each planet gear of said plurality of planet gears comprises:
an annular planet gear rim, said annular planet gear rim having a constant inner radius along a complete axial length and an outer radius defined as the radial distance to the root of the gear teeth, the constant inner radius and the outer radius defining a gear rim thickness therebetween, said annular planet gear rim further having an average rim radius defined at a point between the constant inner radius and the outer radius where stresses and strains within the planet gear rim are zero when radial and transverse components of a plurality of gear tooth forces are applied to the planet gear rim, and wherein a ratio of the average rim radius divided by the rim thickness is in a range of 4 to 9; and
a rolling element bearing assembly comprising an inner annular bearing ring and a plurality of rolling bearing elements disposed circumferentially around the inner annular bearing ring, wherein said annular planet gear rim is disposed circumferentially about said plurality of rolling bearing elements, and wherein said plurality of rolling bearing elements are axially retained by said inner annular bearing ring.

15. The turbomachine of claim 14, wherein the turbomachine is an aircraft engine geared drive fan system.

16. The turbomachine of claim 14, wherein said sun gear, said plurality of planet gears, said ring gear, and said carrier are configured in a planetary configuration.

17. The turbomachine of claim 14, wherein said sun gear, said plurality of planet gears, said ring gear, and said carrier are configured in a star configuration.

18. The turbomachine of claim 14, wherein said sun gear, said plurality of planet gears, said ring gear, and said carrier are configured in a solar configuration

19. The turbomachine of claim 04, further comprising a shaft, wherein the rolling element bearing assembly is disposed about the shaft and rotatable therewith.

20. The turbomachine of claim 14, wherein said rolling element bearing assembly is coupled to an outer surface of the shaft.
